(19) United States
(12) Patent Application Publication
(10) Pub. No.: US 2026/0316455 A1
(43) Pub. Date: Oct. 15, 2026

(54) PRINTING DEVICE, CONTROL DEVICE, AND METHOD FOR CONTROLLING PRINTING DEVICE

(71) Applicant: FUJI CORPORATION, Chiryu (JP)

(72) Inventors: Shunji MORIKAWA, Toyoake-shi (JP); Kazumasa OKAMOTO, Chiryu-shi (JP)

(73) Assignee: FUJI CORPORATION, Chiryu (JP)

(21) Appl. No.: 19/483,477

(22) PCT Filed: May 30, 2023
(86) PCT No.: PCT/JP2023/020036

§ 371 Date: Nov. 11, 2025

(51) Int. Cl. B41J 2/175; B41J 11/00

(52) U.S. Cl. CPC B41J 2/17523; B41J 2/17566; B41J 2/17596; B41J 11/00214

(57) ABSTRACT

A printing device includes a discharge head configured to discharge fluid, a connection section to which an accommodation member that accommodates the fluid is connectable, a fluid flow path that connects the discharge head and the connection section, a liquid feeding section configured to cause the fluid to flow through the fluid flow path, a detection section provided in the fluid flow path, the detection section being configured to detect whether the fluid is present in the fluid flow path and/or measure an amount of the fluid accommodated in the accommodation member, and a control section configured to perform connection state determination as to whether a connection state of the connection section is normal based on a detection value of the detection section when the liquid feeding section causes the fluid to flow through the fluid flow path.

### TECHNICAL FIELD

The present description discloses a printing device, a control device, a method for controlling a printing device.

### BACKGROUND ART

Conventionally, as a printing device, there has been proposed a printing device that includes a supply flow path that connects an exchangeable ink cartridge and a recording head that discharges ink, a pump that can supply ink stored at a merging point with the supply flow path, and an ink detection sensor that detects ink in the supply flow path on an ink cartridge side with respect to the merging point (for example, refer to Patent Literature 1). With the printing device, it is possible to provide a small ink supply device having a simple configuration.

### CITATION LIST

### Patent Literature

Patent Literature 1: JP-A-2007-1295

### BRIEF SUMMARY

### Technical Problem

However, in the printing device described in Patent Literature 1, a situation in which the ink cartridge is not correctly connected or the like is not assumed, and when the ink cartridge is not correctly connected, there is a case where production of a printed matter cannot be executed. In such a printing device, it is required to be capable of more reliably producing a printed matter.

The present disclosure has been made to solve such a problem, and an object of the present disclosure is to provide a printing device, a control device, and a method for controlling a printing device, with which it is possible to more reliably execute production of a printed matter.

The present disclosure adopts the following means to achieve the above-described main object.

A printing device disclosed in the present description includes:
a discharge head configured to discharge fluid;
a connection section to which an accommodation member that accommodates the fluid is connectable;
a fluid flow path that connects the discharge head and the connection section;
a liquid feeding section configured to cause the fluid to flow through the fluid flow path;
a detection section provided in the fluid flow path, the detection section being configured to detect whether the fluid is present in the fluid flow path and/or measure an amount of the fluid accommodated in the accommodation member; and
a control section configured to perform connection state determination as to whether a connection state of the connection section is normal based on a detection value of the detection section when the liquid feeding section causes the fluid to flow through the fluid flow path.

In the printing device, since it is possible to determine whether the accommodation member that accommodates the fluid is appropriately connected to the connection section based on the detection value of the detection section, it is possible to more reliably execute production of a printed matter.

### BRIEF DESCRIPTION OF DRAWINGS

FIG. 1 is a schematic diagram illustrating examples of production system 10 and three-dimensional printer 11.

FIG. 2 is a diagram illustrating an example of a schematic configuration of first discharge head 32 and first supply section 50.

FIG. 3 is a diagram illustrating an example of a schematic configuration of second discharge head 42 and second supply section 80.

FIG. 4 is a flowchart showing an example of a connection state determination processing routine.

FIG. 5 is a diagram of an example of connection state determination processing.

FIG. 6 is a diagram of an example of the connection state determination processing.

FIG. 7 is a diagram of an example in which there is a problem in a connection state of first accommodation member 51.

FIG. 8 is a flowchart illustrating an example of a printing process routine.

FIG. 9 is a diagram illustrating an example of first supply section 50A including another fluid amount measurement section.

### DESCRIPTION OF EMBODIMENTS

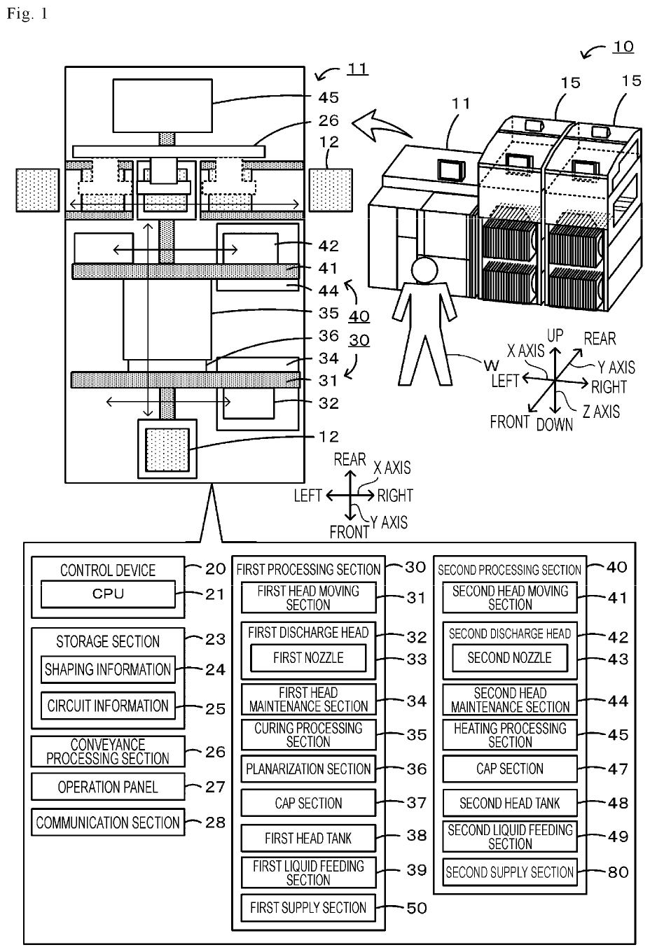

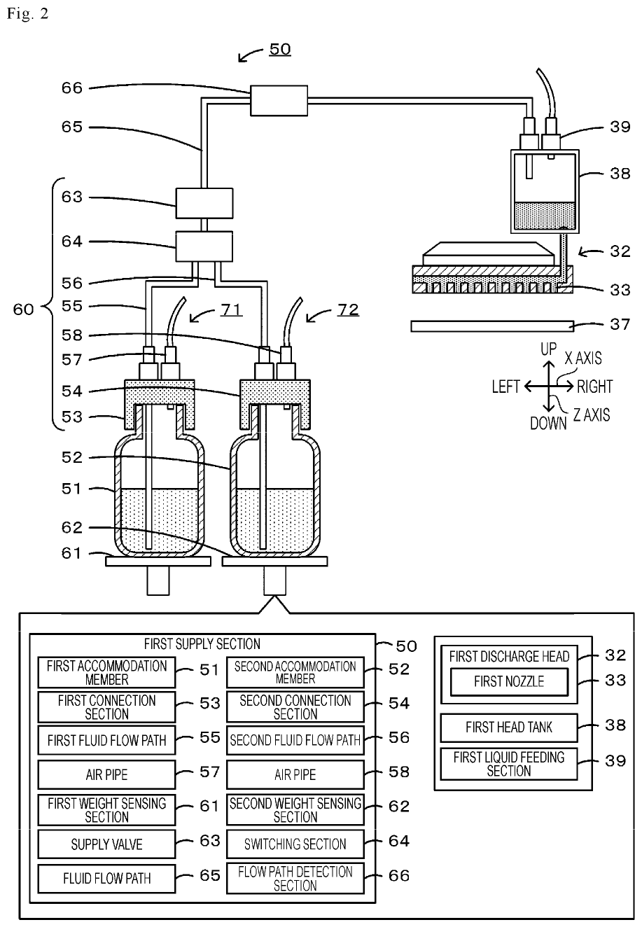

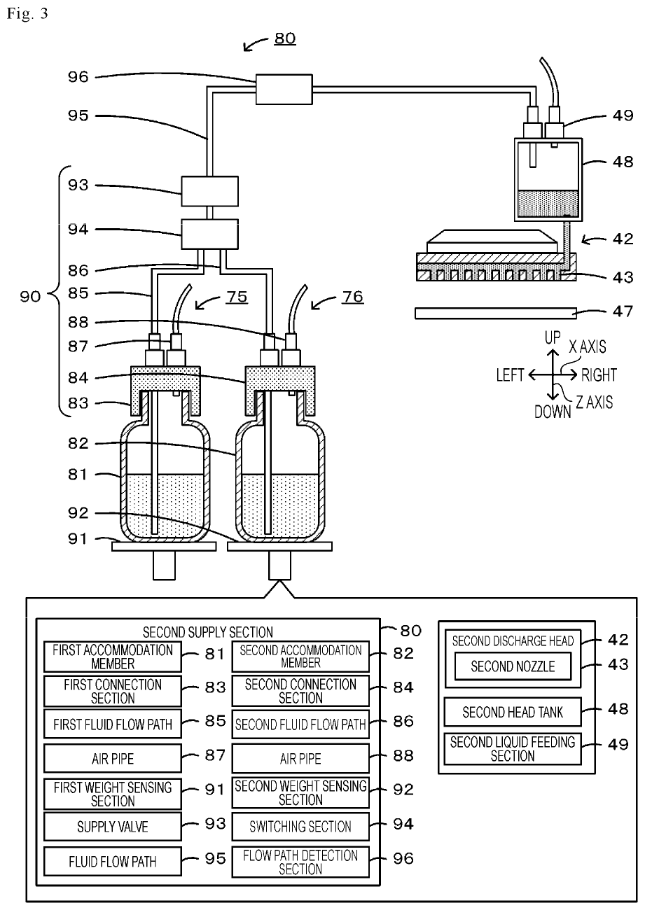

The present embodiment will be described below with reference to drawings. FIG. 1 is a schematic diagram illustrating an example of production system 10 including three-dimensional printer 11 as an example of a printing device according to the present disclosure. FIG. 2 is a diagram illustrating an example of a schematic configuration of first discharge head 32 and first supply section 50. FIG. 3 is a diagram illustrating an example of a schematic configuration of second discharge head 42 and second supply section 80. In the present embodiment, a left-right direction (X axis), a front-rear direction (Y axis), and an up-down direction (Z axis) are as illustrated in FIGS. 1 to 3.

Production system 10 is configured as a production line in which three-dimensional printer 11 shapes a three-dimensional object as a first process and forms a predetermined member on the three-dimensional object as a second process, and then mounting device 15 executes a process of mounting a component. Three-dimensional printer 11 may form a circuit pattern as the second process, and mounting device 15 may execute a process of mounting a component at a predetermined position of the circuit pattern. Production system 10 may include only three-dimensional printer 11 without including mounting device 15, or may include, in addition to mounting device 15, one or more mounting-related devices among a printing device that prints solder as viscous fluid, a printing inspection device that inspects a printing result, a mounting inspection device that inspects a mounting result, a conveyance device that conveys the shaped three-dimensional object, a reflow device that performs a reflow process, and the like. In production system 10, a unit that forms a connection section between an electrode of a component and a circuit pattern may be provided in three-dimensional printer 11, mounting device 15, or another device. The unit may form the connection section by, for example, discharging a conductive paste using a dispenser. In this case, as the conductive paste, for example, a conductive paste in which flaky metal particles are dispersed in a resin that is cured by heating may be used. In this case, the unit may cure the resin by heating the discharged conductive paste. In the conductive paste, the resin is cured and contracted, and the flaky metal particles dispersed in the resin come into contact with each other. Consequently, the conductive paste exhibits conductivity. In production system 10 shown in FIG. 1, two mounting devices 15 are provided, but three or more mounting devices 15 may be provided, or one mounting device 15 may be provided. Mounting device 15 is a device that mounts a component on a three-dimensional object shaped by three-dimensional printer 11.

Three-dimensional printer 11 is a device configured to shape a three-dimensional object. A material for shaping is not particularly limited, and examples thereof include resins and ceramics. Three-dimensional printer 11 includes control device 20, storage section 23, conveyance processing section 26, operation panel 27, communication section 28, first processing section 30, and second processing section 40. Here, a configuration will be mainly described in which three-dimensional printer 11 shapes a board as a base material of the three-dimensional object by using first processing section 30, and executes a process of forming a circuit pattern on the shaped board by using second processing section 40.

Control device 20 is configured as a microprocessor centered on CPU 21 as a control section, and controls entire three-dimensional printer 11. Control device 20 exchanges information with storage section 23, conveyance processing section 26, operation panel 27, communication section 28, first processing section 30, and second processing section 40. Storage section 23 is a large-capacity storage medium, and includes, for example, HDD or a flash memory. Storage section 23 stores shaping information 24 or circuit information 25. Shaping information 24 includes information on a shape and size of a three-dimensional object to be manufactured. Circuit information 25 includes information on a circuit pattern or the like to be formed in a three-dimensional object shape. Three-dimensional printer 11 executes work based on the information stored in storage section 23. As will be described in detail later, for example, control device 20 performs connection state determination as to whether a connection state of connection section 60 is normal based on a detection value of flow path detection section 66 when first liquid feeding section 39 causes a liquid material to flow through fluid flow path 65.

Conveyance processing section 26 moves and fixes pallet 12 on which a product is placed. As illustrated in FIG. 1, conveyance processing section 26 grips pallet 12, moves pallet 12 in an X axis direction, and moves pallet 12 in a Y axis direction along a guide. Conveyance processing section 26 scans pallet 12 in the Y axis direction also when members are formed by first processing section 30 and second processing section 40.

Operation panel 27 is a unit that receives input from worker W and presents information to worker W. Operation panel 27 is disposed on a front surface of three-dimensional printer 11 and includes a display section serving as a display, a touch-panel type operation section, and an operation section including a button. Communication section 28 is an interface used when communicating with an external device such as mounting device 15 or a management device (not illustrated). Each device of production system 10 exchanges information via communication section 28.

First processing section 30 is a shaping unit that shapes a three-dimensional object by discharging a liquid material as fluid to be cured and then curing the liquid material. First processing section 30 includes first head moving section 31, first discharge head 32, first head maintenance section 34, curing processing section 35, planarization section 36, cap section 37, first head tank 38, first liquid feeding section 39, and first supply section 50. First head moving section 31 includes a slider that moves in the X axis direction by being guided by guide rails, and a motor that drives the slider. First discharge head 32 is mounted on the slider, and first discharge head 32 moves in the X axis direction along with the movement of the slider. First discharge head 32 is a shaping head that discharges the liquid material to shape the three-dimensional object. First nozzle 33 that discharges the liquid material is formed on a lower surface of first discharge head 32. Examples of the liquid material discharged from first nozzle 33 include a liquid curable resin (for example, an ultraviolet curable resin, a thermosetting resin, or a two-component curable resin), a thermoplastic resin, a slurry obtained by mixing a solid material such as an inorganic material with a solvent, a resin ink, a structural material, and an underfill. In first discharge head 32, a discharge drive section (not illustrated) is disposed near first nozzle 33, and droplets of the liquid material are discharged from first nozzle 33 by driving the discharge drive section.

First head maintenance section 34 is a unit that performs discharge maintenance of first discharge head 32. Examples of the discharge maintenance include maintenance of a discharge state of the liquid material from first nozzle 33 and cleaning of first nozzle 33. Curing processing section 35 is a unit that performs a predetermined curing process on the liquid material discharged onto pallet 12 and cures the liquid material. In a case where first discharge head 32 discharges a liquid ultraviolet curable resin, curing processing section 35 is a unit that emits ultraviolet rays. In a case where first discharge head 32 discharges the liquid material to be cured by drying and firing, curing processing section 35 may be a unit that executes drying and firing. In curing processing section 35, each time one layer of the three-dimensional object is formed on pallet 12 by first discharge head 32, pallet 12 is moved and accommodated, and the three-dimensional object is solidified. Planarization section 36 is a unit that planarizes the liquid material discharged onto pallet 12. Planarization section 36 may, for example, run a roller and/or blade for planarization in the Y-axis direction to planarize the upper surface of the discharged material. Cap section 37 is a unit that seals first nozzle 33 when first nozzle 33 is not used for a long period of time or when there is a predetermined blank time during the shaping. Cap section 37 may be a wet cap mechanism in which a sealing space is in a wet state, or may be a dry cap mechanism in which the sealing space is not in a wet state.

First head tank 38 is a container that accommodates a liquid material, and is provided in first discharge head 32. First head tank 38 accommodates the liquid material supplied from first supply section 50 and supplies the liquid material to first nozzle 33 via a pipe. Fluid flow path 65 connected to first supply section 50 is disposed in an upper portion of first head tank 38. First liquid feeding section 39 includes a pressure supply section (not illustrated) and is disposed above first head tank 38. First liquid feeding section 39 supplies a positive pressure or a negative pressure to an inside of first head tank 38 to move the liquid material in fluid flow path 65 between first supply section 50 and first head tank 38 or between first head tank 38 and first nozzle 33. For example, when first liquid feeding section 39 applies a positive pressure to first head tank 38 in a state in which first nozzle 33 is sealed by cap section 37, the liquid material in fluid flow path 65 connected to the upper portion of first head tank 38 is fed to first supply section 50 side. When first liquid feeding section 39 applies a negative pressure to first head tank 38 in a state in which first nozzle 33 is sealed by cap section 37, the liquid material is fed from first supply section 50 to first head tank 38 side via fluid flow path 65 connected to the upper portion of first head tank 38. Fluid flow path 65 is a pipe connecting first discharge head 32 and connection section 60, and the liquid material flows inside.

As shown in FIG. 2, first discharge head 32 is connected to first supply section 50, receives the supply of the liquid material from first supply section 50, and feeds the liquid material to first supply section 50. First supply section 50 includes first unit 71, second unit 72, connection section 60, fluid flow path 65, and flow path detection section 66. First unit 71 of first supply section 50 includes first accommodation member 51, first connection section 53, first fluid flow path 55, air pipe 57, and first weight sensing section 61. Second unit 72 of first supply section 50 includes second accommodation member 52, second connection section 54, second fluid flow path 56, air pipe 58, and second weight sensing section 62. In first supply section 50, multiple bottles are connected as accommodation members that accommodate the liquid material, and first supply section 50 is configured to execute the shaping process for a long time by switching between the bottles. In the present embodiment, components of second unit 72 are the same as those of first unit 71, and detailed description thereof will be omitted. Here, for convenience of description, first unit 71 and second unit 72 are collectively referred to simply as a “unit”, first accommodation member 51 and second accommodation member 52 are collectively referred to as an “accommodation member”, and first weight sensing section 61 and second weight sensing section 62 are collectively referred to as a “weight sensing section”. First accommodation member 51 is a bottle that accommodates a liquid material such as a curable resin as fluid. First accommodation member 51 is exchanged by worker W when the liquid material, which is the content, runs out.

Connection section 60 includes first connection section 53 to which first accommodation member 51 can be connected, second connection section 54 to which second accommodation member 52 can be connected, supply valve 63 that moves or stops the liquid material in the fluid flow path, and switching section 64 that switches the flow path between first connection section 53 and second connection section 54. First connection section 53 is a piped lid member that is detachably attached to first accommodation member 51. Air pipe 57 that adjusts an internal pressure of first accommodation member 51 is disposed in first connection section 53. Second connection section 54 is a piped lid member that is detachably attached to second accommodation member 52. Air pipe 58 that adjusts an internal pressure of second accommodation member 52 is disposed in second connection section 54. Supply valve 63 is an electromagnetic valve that opens and closes the flow of the liquid material. Supply valve 63 switches between opening and closing of the flow path based on a control signal from control device 20. Switching section 64 is an electromagnetic valve that switches the flow path between fluid flow path 65 and first connection section 53 or second connection section 54. Switching section 64 switches the flow path based on a control signal from control device 20. Connection section 60 includes first fluid flow path 55 connected to first accommodation member 51 and switching section 64, and second fluid flow path 56 connected to second accommodation member 52 and switching section 64. A distal end of first fluid flow path 55 is fixed to a bottom portion of first accommodation member 51. A distal end of second fluid flow path 56 is fixed to a bottom portion of second accommodation member 52.

First weight sensing section 61 senses that first accommodation member 51 is disposed at a disposition position near connection section 60. First weight sensing section 61 may sense whether first accommodation member 51 is disposed at the disposition position based on information on a weight of first accommodation member 51. For example, first weight sensing section 61 may adopt a high-precision configuration with higher sensing accuracy with which a specific value of the weight can be measured by a load cell or the like, or may adopt a simple configuration of detecting the disposition of first accommodation member 51 by detecting sinking due to the weight of first accommodation member 51. As an example of the simple configuration, for example, there is a mechanism including a table with a built-in spring and a photomicrosensor that senses sinking of the table, in which first accommodation member 51 is disposed on the table, and when the table sinks to a certain position, the photomicrosensor senses the sinking to sense the disposition of first accommodation member 51. When first weight sensing section 61 has the high-precision configuration, first weight sensing section 61 may be a fluid amount measurement section that measures the amount of fluid accommodated in first accommodation member 51. For example, first weight sensing section 61 may output the weight of first accommodation member 51 to control device 20. Similarly to first weight sensing section 61, second weight sensing section 62 senses that second accommodation member 52 is disposed at a disposition position near connection section 60. Second weight sensing section 62 may have the same configuration as first weight sensing section 61 or may have a different configuration, but it is more preferable that second weight sensing section 62 has the same configuration.

Flow path detection section 66 is a sensor that is provided in fluid flow path 65 and detects whether the liquid material is present in fluid flow path 65. Flow path detection section 66 may be a contact sensor or a non-contact sensor. Flow path detection section 66 may be, for example, a non-contact sensor that irradiates fluid flow path 65 with light and detects the presence or absence of the liquid material according to whether light is received by a light receiving section depending on a difference in refractive index.

Second processing section 40 is a discharge unit that forms a predetermined material on a surface of the three-dimensional object cured by first processing section 30. As shown in FIGS. 1 and 3, second processing section 40 includes second head moving section 41, second discharge head 42, second head maintenance section 44, heating processing section 45, cap section 47, second head tank 48, second liquid feeding section 49, and second supply section 80. Second head moving section 41 has the same mechanism as the slider, the motor, and the like of first head moving section 31, and the detailed description thereof will be omitted. Second discharge head 42 is a forming head that discharges the liquid material and forms a circuit pattern or the like. Second nozzle 43 that discharges the liquid material is formed on a lower surface of second discharge head 42. Examples of the liquid material discharged from second nozzle 43 include a mixed liquid obtained by mixing a solid material in a solvent, and a solution obtained by dissolving a resin in a solvent. Examples of the liquid material for forming the circuit pattern include a mixed liquid in which metal powder as a conductive material is dispersed in an organic solvent, and a metal ink conductive fluid. Second discharge head 42 includes second head tank 48, second liquid feeding section 49, and a discharge drive section having the same configurations as first head tank 38, first liquid feeding section 39, the discharge drive section, and the like. Second supply section 80 has the same configuration as that of first supply section 50, and detailed description thereof will be omitted. Second supply section 80 includes, for example, first accommodation member 81, second accommodation member 82, first weight sensing section 91, second weight sensing section 92, fluid flow path 95, flow path detection section 96, first unit 75, second unit 76, and the like having the same configuration as first accommodation member 51, second accommodation member 52, first weight sensing section 61, second weight sensing section 62, fluid flow path 65, flow path detection section 66, first unit 71, second unit 72, and the like. Second supply section 80 includes, for example, connection section 90 including first connection section 83, second connection section 84, first fluid flow path 85, second fluid flow path 86, air pipe 87 and 88, supply valve 93, switching section 94, and the like, which has the same configuration as connection section 60 including first connection section 53, second connection section 54, first fluid flow path 55, second fluid flow path 56, air pipe 57 and 58, supply valve 63, switching section 64, and the like.

Second head maintenance section 44 includes a mechanism similar to that of first head maintenance section 34, and the detailed description thereof will be omitted. Heating processing section 45 is a unit that executes a process of drying the solvent contained in the liquid material formed on the surface of the three-dimensional object. Pallet 12 may be accommodated and dried in heating processing section 45 after the entire circuit pattern is formed by second discharge head 42, or pallet 12 may be accommodated and dried each time a part of the circuit pattern is formed by second discharge head 42. Cap section 47 has the same configuration as cap section 37 of first processing section 30, and the detailed description thereof will be omitted.

The configurations of first discharge head 32 and second discharge head 42 are not limited to those described above, and may be changed as appropriate in accordance with intended use or desired specification. First discharge head 32 has one nozzle row, but may have, for example, two or more nozzle rows. In addition, first discharge head 32 has one flow path to which first nozzle 33 is connected, but may have two or more flow paths. Furthermore, although first supply section 50 includes first accommodation member 51 and second accommodation member 52, first supply section 50 may include three or more accommodation members such as a third accommodation member and a fourth accommodation member depending on the discharge unit, or second accommodation member 52 and switching section 64 may be omitted to provide one accommodation member. In addition, first discharge head 32 and second discharge head 42 have the same structure, but are not particularly limited thereto, and may have different structures. Furthermore, a third discharge head or a fourth discharge head may be provided. In the present embodiment, for convenience of description, first discharge head 32 and second discharge head 42 are collectively referred to simply as a “discharge head”, first nozzle 33 and second nozzle 43 are collectively referred to as a “nozzle”, first head maintenance section 34 and second head maintenance section 44 are collectively referred to as a “head maintenance section”, and cap section 37 and cap section 47 are collectively referred to as a “cap section”. Here, first head tank 38 and second head tank 48 are collectively referred to as a “head tank”, first liquid feeding section 39 and second liquid feeding section 49 are collectively referred to as a “liquid feeding section”, and first fluid flow path 55, second fluid flow path 56, and fluid flow path 65 are collectively referred to as a “fluid flow path”.

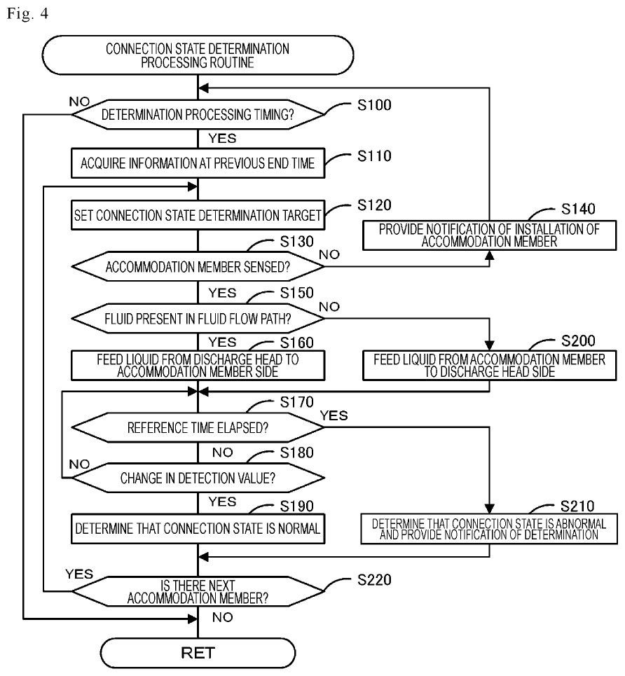

First, a discharge maintenance process of three-dimensional printer 11 configured as described above will be described. FIG. 4 is a flowchart showing an example of a connection state determination processing routine executed by CPU 21 of control device 20. The routine is stored in storage section 23, and is executed after three-dimensional printer 11 is activated and before the production is started. Here, for convenience of description, connection state determination processing of first processing section 30 will be mainly described, and connection state determination processing of second processing section 40 will be omitted, but the connection state determination processing of second processing section 40 can also be performed in the same manner as the following description. Here, an example will be mainly described in which the connection state determination is executed using detection section 66, and the weight sensing section has the simple configuration and senses whether the accommodation member is disposed at the disposition position. In addition, control device 20 may execute the connection state determination processing when performing a system check before production system 10 starts production. In the system check, for example, control device 20 may check input and output of signals from first weight sensing section 61, second weight sensing section 62, and flow path detection section 66, a pressure application state of pressurization and depressurization of first liquid feeding section 39, and the like.

When the routine is executed, CPU 21 first determines whether it is a connection state determination processing timing (S100). The determination processing timing may be, for example, the start of new production or after exchange of first accommodation member 51 or second accommodation member 52. Here, as an example, it is assumed that the new production start time is set as the determination processing timing. When it is not the determination processing timing, CPU 21 ends the routine. On the other hand, when it is the determination processing timing, CPU 21 acquires information at the previous end time (S110). The information at the previous end time includes, for example, information such as information on whether first unit 71 or second unit 72 has been used in the previous time, information on whether the accommodation member has not been exchanged, and the like. Next, CPU 21 sets a target for determining the connection state of the fluid flow path (S120). CPU 21 may set the used unit whose connection state is highly likely to be maintained as a determination target. Here, for convenience of description, a case where second unit 72 (second accommodation member 52) is set as the determination target after first unit 71 (first accommodation member 51) is set as the determination target will be described as a specific example.

Next, CPU 21 determines whether the accommodation member is sensed based on output values from first weight sensing section 61 and second weight sensing section 62 (S130). When the accommodation member is not disposed on the weight sensing section, CPU 21 determines that the accommodation member is not sensed. When the accommodation member set as the determination target is not sensed, CPU 21 notifies worker W of a message indicating that the accommodation member is to be disposed on the weight sensing section (S140), and executes the processing of S100 and subsequent steps. When notifying worker W of the work content, CPU 21 may display the message indicating the above content on operation panel 27, for example. On the other hand, when the accommodation member is sensed in S130, CPU 21 determines whether the fluid (liquid material) is present inside fluid flow path 65 based on the output value of flow path detection section 66 (S150). When the liquid material is present inside fluid flow path 65, CPU 21 causes the liquid feeding section to feed the liquid material from the discharge head to an accommodation member side (S160). CPU 21 performs, for example, a process of sealing first nozzle 33 with cap section 37 and applying a positive pressure to first head tank 38 using first liquid feeding section 39 in first unit 71. In this case, CPU 21 activates a timer (not illustrated).

Next, CPU 21 determines whether a predetermined reference time has elapsed (S170) after controlling the liquid feeding section such that the liquid feeding section feeds the liquid material from the discharge head to the accommodation member side. The reference time may be specified as a time sufficient for the rear end of the liquid material to pass through flow path detection section 66 from the start of liquid feeding based on, for example, a liquid feeding rate of the liquid feeding section and a position of flow path detection section 66 from first head tank 38. Specifically, the reference time may be set by empirically obtaining the time when the rear end of the liquid material is pushed back by the application of the positive pressure of first liquid feeding section 39 and passes through flow path detection section 66 when the liquid material is filled up to the front end of fluid flow path 65, and adding a predetermined margin to the obtained time as necessary. When the reference time has not elapsed in S170, CPU 21 determines whether there is a change in the detection value of flow path detection section 66 (S180), and when there is no change in the detection value, the processing of S170 and S180 is repeatedly executed. That is, CPU 21 continues to feed the liquid material to the accommodation member side. On the other hand, when there is a change in the detection value in S180, that is, when there is a change from a state in which the liquid material is detected to a state in which the liquid material is stopped and not detected, CPU 21 determines that the connection state of the connection section is normal (S190).

On the other hand, when it is determined in S150 that there is no liquid material in fluid flow path 65, CPU 21 controls the liquid feeding section such that the liquid feeding section feeds the liquid material from the accommodation member to a discharge head side (S200). CPU 21 performs, for example, a process of sealing first nozzle 33 with cap section 37 and applying a negative pressure to first head tank 38 using first liquid feeding section 39 in first unit 71. In this case, CPU 21 activates a timer (not illustrated). Next, CPU 21 determines whether a predetermined reference time has elapsed in S170 after controlling the liquid feeding section such that the liquid feeding section feeds the liquid material from the accommodation member to the discharge head side. The reference time may be specified as a time sufficient for the front end of the liquid material to pass through flow path detection section 66 from the start of liquid feeding based on, for example, the liquid feeding rate of the liquid feeding section and a position from the accommodation member to flow path detection section 66. Specifically, the reference time may be set by empirically obtaining the time when the front end of the liquid material is pushed to a fluid flow path 65 side by the application of the negative pressure of first liquid feeding section 39 and passes through flow path detection section 66 when first fluid flow path 55 or second fluid flow path 56 is vacant, and adding a predetermined margin to the obtained time as necessary. When the reference time has not elapsed in S170, CPU 21 determines in S180 whether there is a change in the detection value of flow path detection section 66, and when there is no change in the detection value, the processing of S170 and S180 is repeatedly executed. That is, CPU 21 continues to feed the liquid material to the discharge head side. On the other hand, when there is a change in the detection value in S180, that is, when there is a change from a state in which the liquid material is not detected to a state in which the liquid material is detected, CPU 21 determines in S190 that the connection state of the connection section is normal.

On the other hand, when the reference time has elapsed in S170 in a state in which there is no change in the detection value of flow path detection section 66, CPU 21 determines that the connection state of the connection section is not normal, that is, abnormal, and notifies worker W of the determination (S210). CPU 21 causes operation panel 27 to display and output a message indicating that the connection state of first connection section 53 or second connection section 54 is abnormal. Worker W who has recognized this executes work of making the connection state of the abnormal connection section normal. CPU 21 can estimate that the connection state of first connection section 53 or second connection section 54 is not normal when the detection value of flow path detection section 66 does not change even after the reference time elapses. In first supply section 50, worker W performs work of replacing first accommodation member 51 or second accommodation member 52, but may forget to connect first connection section 53 or second connection section 54. Control device 20 of three-dimensional printer 11 determines such a connection state and prevents the liquid material from being depleted during production.

After S210 or S190, CPU 21 determines whether there is an accommodation member for which the connection state is to be determined next (S220), and when there is an accommodation member for which the connection state is to be determined next, CPU 21 executes the processing of S120 and subsequent steps. That is, CPU 21 sets an accommodation member as a next target for determining the connection state of the fluid flow path in S120, causes the liquid material to flow through fluid flow path 65 in S160 or S200, acquires a change or the like in the detection value of flow path detection section 66, and determines whether the connection state of connection section 60 is normal. On the other hand, in S220, when there is no accommodation member for which the connection state is to be determined next, the routine is ended. In this way, control device 20 detects the connection state of connection section 60 using the detection value of flow path detection section 66.

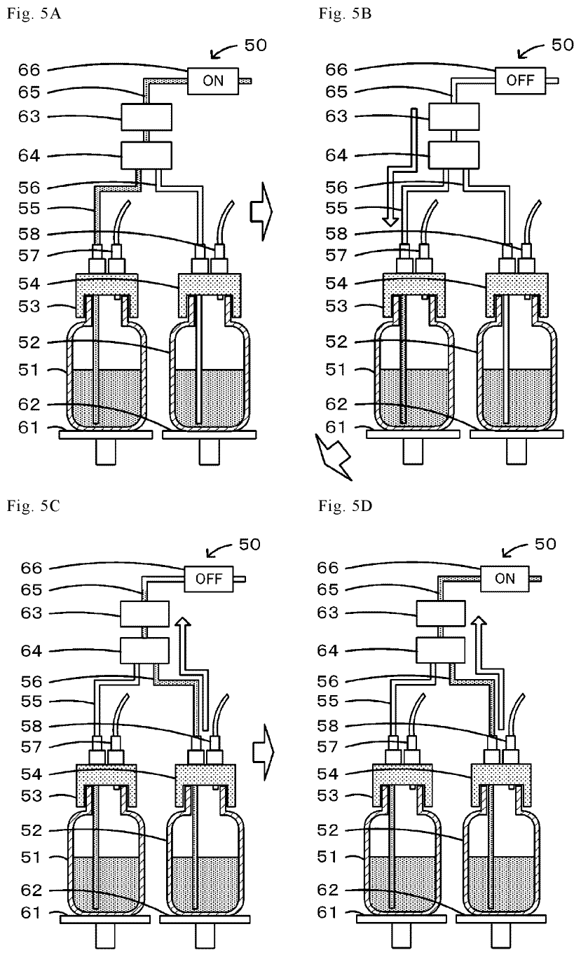

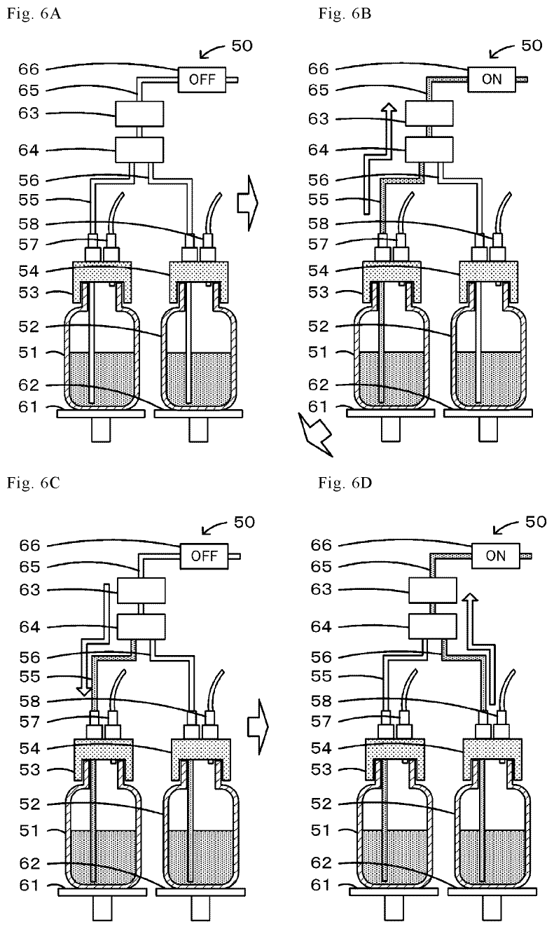

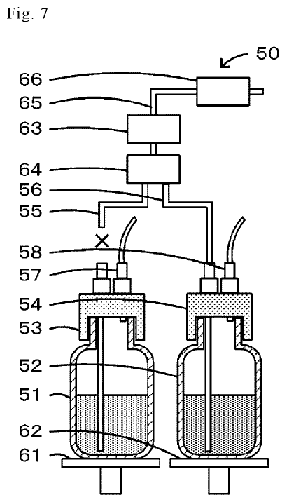

FIG. 5 is a diagram of an example of the connection state determination processing of the fluid flow path, in which FIG. 5A is a diagram in which the determination processing is started from a state in which the liquid material is present in fluid flow path 65, FIG. 5B is a diagram in which the liquid material is fed from first discharge head 32 to a first accommodation member 51 side and passes through flow path detection section 66, FIG. 5C is a diagram in which the liquid material is fed from second accommodation member 52 to a first discharge head 32 side, and FIG. 5D is a diagram in which the liquid material passes through flow path detection section 66. FIG. 6 is a diagram of an example of the connection state determination processing of the fluid flow path, in which FIG. 6A is a diagram in which the determination processing is started from a state in which there is no liquid material in fluid flow path 65, FIG. 6B is a diagram in which the liquid material is fed from first accommodation member 51 to a first discharge head 32 side and passes through flow path detection section 66, FIG. 6C is a diagram in which the liquid material is fed from first discharge head 32 to the first accommodation member 51 side, and FIG. 6D is a diagram in which the liquid material is fed from second accommodation member 52 to first discharge head 32 and passes through flow path detection section 66. As shown in FIGS. 5 and 6, in a case where first fluid flow path 55 to first accommodation member 51 and second fluid flow path 56 to second accommodation member 52 are normally connected, the detection value of flow path detection section 66 changes when the rear end or the front end of the liquid material passes. FIG. 7 is a diagram of an example in which there is a problem in the connection state of first accommodation member 51. As illustrated in FIG. 7, when the connection state of first connection section 53 is not normal, there may be a case where the detection value does not change in flow path detection section 66. Control device 20 can determine whether the connection state of the fluid flow path of connection section 60 is normal based on such a detection value.

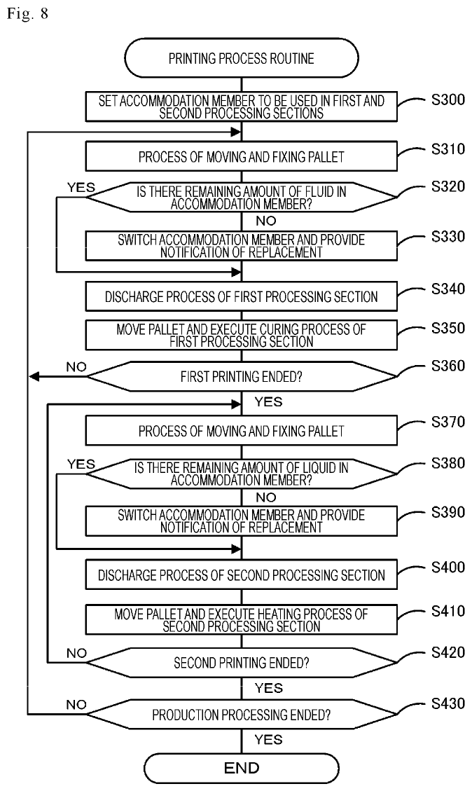

Next, production processing including a shaping process and a circuit pattern forming method of three-dimensional printer 11 will be described. FIG. 8 is a flowchart illustrating an example of a printing process routine executed by CPU 21 of control device 20. The routine is stored in storage section 23 and is executed by control device 20 after an execution command of production processing is input from worker W. When the printing process routine is started, CPU 21 of control device 20 first sets the accommodation members to be used in first processing section 30 and second processing section 40 (S300). CPU 21 reads and acquires information or the like on first accommodation member 51, second accommodation member 52, and the accommodated liquid material which are to be used in the production processing from shaping information 24 and circuit information 25. CPU 21 may set the previously used accommodation member as the accommodation member to be used this time. Next, CPU 21 executes processing of causing conveyance processing section 26 to convey and fix pallet 12 to a work position of first processing section 30 (S310). Next, CPU 21 determines whether there is a remaining amount of the liquid material accommodated in the accommodation member to be used (S320). When there is no remaining amount of the liquid material accommodated in the accommodation member to be used, CPU 21 switches the accommodation member to be used by switching the flow path of switching section 64, and notifies worker W to execute replacement work of the accommodation member having no remaining amount (S330). When notifying worker W of work content, CPU 21 may display a message indicating the work content on operation panel 27, for example. In three-dimensional printer 11, since the connection state of connection section 60 is normal, it is possible to more reliably switch the accommodation member.

After S330 or when there is a remaining amount of the liquid material in the accommodation member in S320, CPU 21 controls first discharge head 32 and conveyance processing section 26 and causes a resin as the liquid material to be discharged onto pallet 12 based on shaping information 24 such that the resin has a predetermined shape included in shaping information 24 (S340). Next, CPU 21 moves pallet 12 to curing processing section 35 and cures the resin (S350). Next, CPU 21 determines whether the printing process in first processing section 30 has been ended (S360), and, when the printing process has not been ended, executes the processing of S310 and the subsequent steps. In this way, CPU 21 repeats the discharge process and the curing process to shape the three-dimensional object on pallet 12. In CPU 21, a planarization process may be performed by planarization section 36 between the discharge process and the curing process.

On the other hand, when the printing process of first processing section 30 has been ended in S360, CPU 21 conveys and fixes pallet 12 on which the shaped three-dimensional object is placed to second processing section 40 (S370). Next, CPU 21 determines whether there is a remaining amount of the liquid material accommodated in the accommodation member to be used (S380). When there is no remaining amount of the liquid material accommodated in the accommodation member to be used, CPU 21 switches the accommodation member to be used by switching the flow path of the switching section, and notifies worker W to execute exchanging work of the accommodation member having no remaining amount (S390). When notifying worker W of work content, CPU 21 may display a message indicating the work content on operation panel 27, for example. In three-dimensional printer 11, since the connection state of connection section 60 is normal, it is possible to more reliably switch the accommodation member. After S390 or when there is a remaining amount of the liquid material in the accommodation member in S380, CPU 21 controls second discharge head 42 and conveyance processing section 26 based on the circuit pattern and the nozzle setting of circuit information 25 such that the liquid material which is a circuit raw material is discharged onto the shaped three-dimensional object (S400). Subsequently, CPU 21 moves pallet 12 to heating processing section 45, and cures the liquid material (S410). Then, CPU 21 determines whether the printing process in second processing section 40 has been ended (S420), and, when the printing process has not been ended, executes the processing of S370 and the subsequent steps. In this manner, CPU 21 repeats the discharge process and the heating process as necessary to form the circuit pattern on the three-dimensional object. Meanwhile, when the printing process of second processing section 40 has been ended in S420, CPU 21 determines whether the production processing of the three-dimensional object as a target object that is a manufacturing target has been completed (S430), and, when the production processing has not been completed, executes the processing of S310 and the subsequent steps. On the other hand, when the production processing has been completed in S430, CPU 21 ends the routine. As described above, in three-dimensional printer 11, since the shaping process and the circuit forming process are executed by switching the multiple accommodation members, it is possible to continue the production work for a long time without stopping the production work.

Here, a correspondence relationship between the elements of the present embodiment and the elements of the present disclosure will be clarified. First discharge head 32 and second discharge head 42 of the present embodiment are examples of a discharge head of the present disclosure, connection sections 60 and 90 are examples of a connection section, fluid flow paths 65 and 95 are examples of a fluid flow path, first liquid feeding section 39 and second liquid feeding section 49 are examples of a liquid feeding section, and CPU 21 is an example of a control section. In addition, first accommodation member 51 and first accommodation member 81 are examples of a first accommodation member, second accommodation member 52 and second accommodation member 82 are examples of a second accommodation member, first connection section 53 and first connection section 83 are examples of a first connection section, second connection section 54 and second connection section 84 are examples of a second connection section, switching section 64 and switching section 94 are examples of a switching section, first weight sensing section 61, second weight sensing section 62, first weight sensing section 91, and second weight sensing section 92 are examples of a sensing section, and curing processing section 35 and heating processing section 45 are examples of a curing section. In the present embodiment, by describing the operation of three-dimensional printer 11 as a printing device, an example of a control device and a method for controlling a printing device of the present disclosure is also clarified.

Three-dimensional printer 11 of the present embodiment described above includes first discharge head 32 configured to discharge the liquid material as fluid; connection section 60 to which first accommodation member 51 and second accommodation member 52 that accommodate the fluid are connectable; fluid flow path 65 that connects first discharge head 32 and connection section 60; first liquid feeding section 39 configured to cause the fluid to flow through fluid flow path 65; flow path detection section 66 provided in fluid flow path 65, flow path detection section 66 being configured to detect whether the fluid is present in fluid flow path 65; and CPU 21 as a control section configured to perform the connection state determination as to whether the connection state of connection section 60 is normal based on the detection value of flow path detection section 66 when first liquid feeding section 39 causes the fluid to flow through fluid flow path 65. In three-dimensional printer 11, since it is possible to determine whether first accommodation member 51 or second accommodation member 52 accommodating the fluid is appropriately connected to connection section 60 based on the detection value of flow path detection section 66, it is possible to more reliably execute the production of the printed matter.

In addition, CPU 21 performs the connection state determination on connection section 60 based on a change in the detection value of flow path detection section 66 when the fluid is caused to flow from the first discharge head 32 side to a connection section 60 side and the fluid is stopped, and a change in the detection value of flow path detection section 66 when the fluid is caused to flow from the connection section 60 side to the first discharge head 32 side and the fluid is detected. In three-dimensional printer 11, it is possible to move the fluid to determine whether the connection state of connection section 60 is normal using a change in the detection value at the leading end portion or the trailing end portion of the fluid. In three-dimensional printer 11, first discharge head 32 includes first head tank 38 that stores the fluid for discharging, and fluid flow path 65 is connected to an upper side of first head tank 38. In three-dimensional printer 11, first liquid feeding section 39 applies a positive pressure and/or a negative pressure to first head tank 38 to cause the fluid to flow between first accommodation member 51 and second accommodation member 52, and first head tank 38. In three-dimensional printer 11, the fluid can be fed by first head tank 38 and first liquid feeding section 39.

In addition, CPU 21 determines that first accommodation member 51 or second accommodation member 52 is connected to connection section 60 when the fluid is caused to flow through fluid flow path 65 and the detection value of flow path detection section 66 is changed before the reference time specified based on the liquid feeding rate of first liquid feeding section 39 and the position of flow path detection section 66 elapses, and determines that first accommodation member 51 or second accommodation member 52 is not connected to connection section 60 when the detection value of flow path detection section 66 is not changed even after the reference time elapses. In three-dimensional printer 11, it is possible to determine the connection state of connection section 60 using the elapse of the reference time. Further, connection section 60 includes first connection section 53 to which first accommodation member 51 is connectable, second connection section 54 to which second accommodation member 52 is connectable, and switching section 64 configured to switch the flow path between first connection section 53 and second connection section 54, and CPU 21 performs the connection state determination on first connection section 53 or second connection section 54 and then performs the connection state determination on second connection section 54 or first connection section 53 by switching the flow path using switching section 64. In three-dimensional printer 11, since it is possible to use multiple accommodation members while switching the flow path, it is possible to manufacture the printed matter for a long time. In addition, in three-dimensional printer 11, since it is possible to inspect a connection error or the like of connection section 60 when manufacturing for such a long time, it is possible to more reliably and stably execute manufacturing of the printed matter.

In addition, when the fluid is present in fluid flow path 65 and first fluid flow path 55 between first accommodation member 51 and first discharge head 32, CPU 21 executes the connection state determination on first connection section 53 based on a change in the detection value of flow path detection section 66 when the fluid is caused to flow to the first accommodation member 51 side and the fluid is stopped and then performs the connection state determination on second connection section 54 based on a change in the detection value of flow path detection section 66 when the fluid is caused to flow from a second connection section 54 side to the first discharge head 32 side and the fluid is detected. Alternatively, when the fluid is present in fluid flow path 65 and second fluid flow path 56 between second accommodation member 52 and first discharge head 32, CPU 21 executes the connection state determination on second connection section 54 based on a change in the detection value of flow path detection section 66 when the fluid is caused to flow to a second accommodation member 52 side and the fluid is stopped and then performs the connection state determination on first connection section 53 based on a change in the detection value of flow path detection section 66 when the fluid is caused to flow from a first connection section 53 side to the first discharge head 32 side and the fluid is detected. In three-dimensional printer 11, since the connection state is determined from the connection section on the side filled with the fluid, it is possible to efficiently determine the connection state of connection section 60.

In addition, three-dimensional printer 11 includes first weight sensing section 61 and second weight sensing section 62 configured to sense that first accommodation member 51 or second accommodation member 52 is disposed at the disposition position which is near connection section 60 and on which the accommodation member is to be disposed, and CPU 21 executes the connection state determination when the sensing section senses the accommodation member. In three-dimensional printer 11, by sensing whether the accommodation member is disposed at the disposition position using the sensing section, first, it is possible to prevent forgetting to place the accommodation member. In addition, it is possible to further determine the connection state of the connection section while preventing forgetting to place the accommodation member. Further, the sensing section can sense the disposition of the accommodation member by measuring the weight of the accommodation member. Note that CPU 21 can also perform the connection state determination by supplementarily using information on the weight measured by the sensing section. In three-dimensional printer 11, by using supplementary information such as the weight measured by the sensing section, for example, an amount of fluid moved between the accommodation member and the discharge head, it is possible to further reliably continue to produce the printed matter.

Further, three-dimensional printer 11 includes curing processing section 35 that cures the fluid discharged from first discharge head 32, and first discharge head 32 is a printing device that discharges the fluid to be cured by curing processing section 35. In three-dimensional printer 11, it is possible to more reliably execute the production of the three-dimensional printed matter.

It goes without saying that the printing device, the control device, and the method for controlling a printing device of the present disclosure are not limited to the above-described embodiment, and may be achieved in various aspects within a technical scope of the present disclosure.

For example, in the above-described embodiment, the connection state determination is performed by causing the fluid to flow through fluid flow path 65 and determining whether the detection value of flow path detection section 66 changes before the reference time specified based on the liquid feeding rate of first liquid feeding section 39 and the position of flow path detection section 66 elapses, but the connection state determination may be performed without being particularly limited to the reference time. In three-dimensional printer 11, the connection state determination can be executed more appropriately by using the elapse of the reference time.

In the above-described embodiment, the connection state determination on connection section 60 connected to first supply section 50 that switches and uses first unit 71 and second unit 72 has been described, but the present disclosure is not particularly limited thereto. First supply section 50 may include a single unit or three or more units. It is preferable that first supply section 50 switch the flow paths of the multiple units because it is possible to address the manufacturing for a longer period of time in that case. In addition, in the above-described embodiment, second supply section 80 switches and uses first unit 75 and second unit 76, and includes connection section 90 connected thereto, but the present disclosure is not particularly limited thereto. Second supply section 80 may include a single unit or three or more units. It is preferable that second supply section 80 switch the flow paths of the multiple units because it is possible to address the manufacturing for a longer period of time in that case.

In the above-described embodiment, the connection state determination on connection section 60 that connects first discharge head 32 and first supply section 50 is performed, but the present disclosure is not particularly limited thereto, and in addition to or instead of this, the connection state determination on connection section 90 that connects second discharge head 42 and second supply section 80 may be performed.

In the embodiment described above, flow path detection section 66 and flow path detection section 96 are described as non-contact sensors, but are not particularly limited thereto as long as the presence of the liquid material can be detected, and may be contact sensors.

In the above-described embodiment, the weight sensing section including first weight sensing section 61 that senses the weight of first accommodation member 51 and second weight sensing section 62 that senses the weight of second accommodation member 52 is provided, but the present disclosure is not particularly limited thereto as long as the accommodation member is sensed. For example, the sensing section may be a sensor that detects the presence or absence of the accommodation member by coming into contact with the accommodation member, or may be a non-contact sensor that senses the accommodation member by reflection or blocking of light. In first supply section 50, it is preferable to use a sensor that senses the weight because the remaining amount of the liquid material can also be measured. Alternatively, in the above-described embodiment, the disposition of the accommodation member is sensed using the weight sensing section, but the present disclosure is not particularly limited thereto, and the weight detection section may be omitted. First weight sensing section 91 and second weight sensing section 92 of second supply section 80 are the same as those of first supply section 50 described above.

In the above-described embodiment, first liquid feeding section 39 and second liquid feeding section 49 have been described as those that cause the fluid to flow through fluid flow path 65 by using a positive pressure or a negative pressure, but are not particularly limited thereto as long as the liquid material can be fed, and a liquid feeding pump or the like may be used.

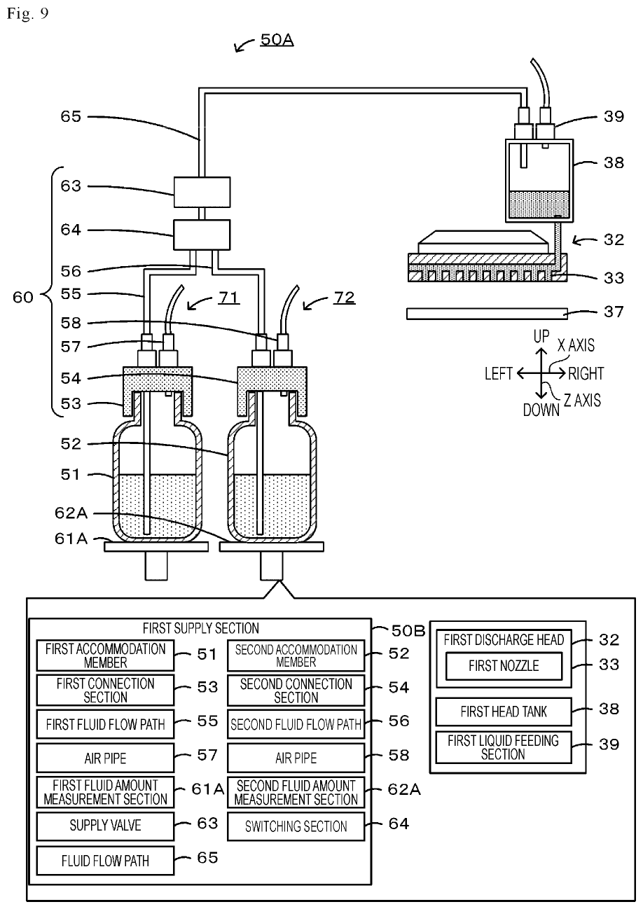

In the above-described embodiment, the connection state determination is performed based on the detection value of the flow path detection section that is provided in the fluid flow path and detects whether the fluid is present in the fluid flow path, but the present disclosure is not particularly limited thereto, and the connection state determination may be performed based on a measurement value of the fluid amount measurement section that measures the amount of the fluid accommodated in the accommodation member. FIG. 9 is a diagram illustrating an example of another first supply section 50A including first fluid amount measurement section 61A and second fluid amount measurement section 62A. Here, first fluid amount measurement section 61A and second fluid amount measurement section 62A are collectively referred to as the fluid amount measurement section. The fluid amount measurement section has the same configuration as the weight sensing section except that a high-precision configuration having high sensing accuracy is adopted. The fluid amount measurement section also has a function of the weight sensing section that senses whether the accommodation member is disposed at the disposition position. Therefore, the configuration of first supply section 50A can be simplified. Further, in first supply section 50A, since the connection state determination can be executed using the measurement value of the fluid amount measurement section, flow path detection section 66 can be omitted. Second supply section 80 may have the same configuration as first supply section 50A. For convenience of description, first supply section 50A will be described. Control device 20 of three-dimensional printer 11 including first supply section 50A executes the connection state determination processing routine shown in FIG. 4. The description of the same processing as the connection state determination processing routine described above will be omitted. When the routine is started, CPU 21 executes the processing of S100 to S160 and S200. Then, in S170, it is determined whether the reference time has elapsed from the start of liquid feeding. For example, the reference time may be specified as a time obtained by empirically obtaining a time in which a clear change in the amount of fluid accommodated in the accommodation member can be detected based on the liquid feeding rate of the liquid feeding section and adding a predetermined margin to the time as necessary. When the reference time has not elapsed in S170, CPU 21 determines whether there is a change in the measurement value of the fluid amount measurement section in S180, and when there is a change in the detection value, CPU 21 determines that the connection state of the connection section is normal in S190. For example, when the liquid is fed from the discharge head to the accommodation member side in S160, CPU 21 determines that the connection state is normal when the fluid amount increases. In addition, in a case where the liquid is fed from the accommodation member to the discharge head side in S200, CPU 21 determines that the connection state is normal when the fluid amount decreases. On the other hand, when the reference time has elapsed in S170 in a state in which there is no change in the measurement value of the fluid amount measurement section, CPU 21 determines that the connection state of the connection section is not normal, that is, abnormal, and notifies worker W of the determination in S210. Then, CPU 21 executes the processing of S220 and subsequent steps. In three-dimensional printer 11, it is possible to determine whether the connection state of the connection section is normal based on the amount of the fluid accommodated in the accommodation member.

In the above-described embodiment, the connection state determination is performed based on either the detection value of the flow path detection section or the measurement value of the fluid amount measurement section, but the present disclosure is not particularly limited thereto, and the connection state determination may be performed based on the detection value of the flow path detection section and the measurement value of the fluid amount measurement section. In this case, CPU 21 may determine that the connection state of the connection section is not normal when there is no change in both the detection value of the flow path detection section and the measurement value of the fluid amount measurement section. In the above-described embodiment, first supply section 50A includes first fluid amount measurement section 61A that measures the weight of first accommodation member 51 and second fluid amount measurement section 62A that measures the weight of second accommodation member 52, but the present disclosure is not particularly limited thereto as long as the amount of fluid accommodated in the accommodation member is measured. For example, the fluid amount measurement section may be a contact sensor or a non-contact sensor that detects a height of a liquid surface of the fluid accommodated in the accommodation member. It may be a sensor that detects the presence or absence of the accommodation member by contact, or may be a non-contact sensor that detects the accommodation member by reflection or blocking of light. In first supply section 50A, it is preferable to use a sensor that senses the weight because the remaining amount of the accommodated fluid can also be measured. First weight sensing section 91 and second weight sensing section 92 of second supply section 80 are the same as those of first supply section 50A described above.

In the above-described embodiment, when the fluid is present in fluid flow path 65, the connection state determination is executed by feeding the fluid from the discharge head to the accommodation member side, but the present disclosure is not particularly limited thereto, and even in such a case, the connection state determination may be executed by feeding the fluid from the accommodation member to the discharge head side. In a case where the connection of the connection section is not normal, the liquid cannot be fed from the accommodation member to the discharge head side, and thus three-dimensional printer 11 can more reliably execute the connection state determination on the connection section.

In the above-described embodiment, three-dimensional printer 11 including control device 20 is described, but the present disclosure is not limited to this, and a configuration including only control device 20 may be used. Control device 20 described above is used in three-dimensional printer 11 that manufactures the three-dimensional object, but is not particularly limited thereto as long as the product is manufactured by discharging the liquid material, and may be used in a printing device other than the three-dimensional printer, for example, an inkjet printer that prints an image. In the above-described embodiment, control device 20 or three-dimensional printer 11 are exemplified, but it may be the method for controlling a printing device or a program thereof.

The present disclosure may be configured as follows. For example, the control device of the present disclosure is
a control device that is used in a printing device including a discharge head configured to discharge fluid, a connection section to which an accommodation member that accommodates the fluid is connectable, a fluid flow path that connects the discharge head and the connection section, a liquid feeding section configured to cause the fluid to flow through the fluid flow path, and a detection section provided in the fluid flow path, the detection section being configured to detect whether the fluid is present in the fluid flow path and/or measure an amount of the fluid accommodated in the accommodation member, and
the control device includes a control section configured to perform connection state determination as to whether a connection state of the connection section is normal based on a detection value of the detection section when the liquid feeding section causes the fluid to flow through the fluid flow path.

In the control device, similarly to the printing device described above, it is possible to more reliably execute the production of the printed matter. It should be noted that various modes of the above-described printing device may be employed in the control device, and a step for achieving each function of the above-described printing device may be added.

A method for controlling a printing device of the present disclosure is
a method for controlling a printing device including a discharge head configured to discharge fluid, a connection section to which an accommodation member that accommodates the fluid is connectable, a fluid flow path that connects the discharge head and the connection section, a liquid feeding section configured to cause the fluid to flow through the fluid flow path, and a detection section provided in the fluid flow path, the detection section being configured to detect whether the fluid is present in the fluid flow path and/or measure an amount of the fluid accommodated in the accommodation member, and
the method includes a step of performing connection state determination as to whether a connection state of the connection section is normal based on a detection value of the detection section when the liquid feeding section causes the fluid to flow through the fluid flow path.

In the method for controlling a printing device, similarly to the printing device described above, it is possible to more reliably execute the production of the printed matter. It should be noted that various modes of the above-described printing device may be employed in the method for controlling a printing device, and a step for achieving each function of the above-described printing device may be added.

### INDUSTRIAL APPLICABILITY

The present disclosure can be used in the technical field of a device for manufacturing a product by discharging a liquid material.

### REFERENCE SIGNS LIST

10: production system, 11: three-dimensional printer, 12: pallet, 15: mounting device, 20: control device, 21: CPU, 23: storage section, 24: shaping information, 25: circuit information, 26: conveyance processing section, 27: operation panel, 28: communication section, 30: first processing section, 31: first head moving section, 32: first discharge head, 33: first nozzle, 34: first head maintenance section, 35: curing processing section, 36: planarization section, 37: cap section, 38: first head tank, 39: first liquid feeding section, 40: second processing section, 41: second head moving section, 42: second discharge head, 43: second nozzle, 44: second head maintenance section, 45: heating processing section, 47: cap section, 48: second head tank, 49: second liquid feeding section, 50, 50A: first supply section, 51, 81: first accommodation member, 52, 82: second accommodation member, 53, 83: first connection section, 54, 84: second connection section, 55, 85: first fluid flow path, 56, 86: second fluid flow path, 57, 87: air pipe, 58, 88: air pipe, 61, 91: first weight sensing section, 62, 92: second weight sensing section, 61A: first fluid amount measurement section (detection section), 62A: second fluid amount measurement section (detection section), 63, 93: supply valve, 64, 94: switching section, 65, 95: fluid flow path, 66, 96: flow path detection section (detection section), 71, 75: first unit, 72, 76: second unit, 80: second supply section, W: worker.

1. A printing device comprising:
a discharge head configured to discharge fluid;
a connection section to which an accommodation member that accommodates the fluid is connectable;
a fluid flow path that connects the discharge head and the connection section;
a liquid feeding section configured to cause the fluid to flow through the fluid flow path;
a detection section provided in the fluid flow path, the detection section being configured to detect whether the fluid is present in the fluid flow path and/or measure an amount of the fluid accommodated in the accommodation member; and
a control section configured to perform connection state determination as to whether a connection state of the connection section is normal based on a detection value of the detection section when the liquid feeding section causes the fluid to flow through the fluid flow path.

2. The printing device according to claim 1,
wherein the detection section is provided in the fluid flow path and is configured to detect whether the fluid is present in the fluid flow path, and
the control section is configured to perform the connection state determination based on a change in the detection value of the detection section when the fluid is caused to flow from a discharge head side to a connection section side and the fluid is stopped and/or a change in the detection value of the detection section when the fluid is caused to flow from the connection section side to the discharge head side and the fluid is detected.

3. The printing device according to claim 1,
wherein the detection section is provided in the fluid flow path and is configured to detect whether the fluid is present in the fluid flow path, and
the control section is configured to
determine that the accommodation member is connected to the connection section when the fluid is caused to flow through the fluid flow path and the detection value of the detection section is changed before a reference time specified based on a liquid feeding rate of the liquid feeding section and a position of the detection section elapses, and
determine that the accommodation member is not connected to the connection section when the detection value of the detection section is not changed even after the reference time elapses.

4. The printing device according to claim 1,
wherein the connection section includes
a first connection section to which a first accommodation member of the accommodation member is connectable,
a second connection section to which a second accommodation member of the accommodation member is connectable, and
a switching section configured to switch a flow path between the first connection section and the second connection section, and
the control section is configured to perform the connection state determination on the first connection section or the second connection section and then perform the connection state determination on the second connection section or the first connection section by switching the flow path using the switching section.

5. The printing device according to claim 4,
wherein the detection section is provided in the fluid flow path and is configured to detect whether the fluid is present in the fluid flow path, and
the control section is configured to
when the fluid is present in the fluid flow path between the first accommodation member and the discharge head, execute the connection state determination on the first connection section based on a change in the detection value of the detection section when the fluid is caused to flow to a first accommodation member side and the fluid is stopped and then perform the connection state determination on the second connection section based on a change in the detection value of the detection section when the fluid is caused to flow from a second connection section side to a discharge head side and the fluid is detected, or
when the fluid is present in the fluid flow path between the second accommodation member and the discharge head, execute the connection state determination on the second connection section based on a change in the detection value of the detection section when the fluid is caused to flow to a second accommodation member side and the fluid is stopped and then perform the connection state determination on the first connection section based on a change in the detection value of the detection section when the fluid is caused to flow from a first connection section side to the discharge head side and the fluid is detected.

6. The printing device according to claim 1, further comprising:
a sensing section configured to sense that the accommodation member is disposed at a disposition position which is near the connection section and on which the accommodation member is to be disposed,
wherein the control section is configured to execute the connection state determination when the sensing section senses the accommodation member.

7. The printing device according to claim 1,
wherein the detection section is configured to measure the amount of the fluid accommodated in the accommodation member, and
the control section is configured to perform the connection state determination as to whether the connection state of the connection section is normal based on an increase or decrease in the amount of the fluid accommodated in the accommodation member when the liquid feeding section causes the fluid to flow through the fluid flow path.

8. The printing device according to claim 7, wherein the detection section is configured to measure the amount of the fluid accommodated in the accommodation member by measuring a weight of the accommodation member.

9. The printing device according to claim 1, further comprising:
a curing section configured to cure the fluid discharged from the discharge head,
wherein the discharge head is configured to discharge the fluid to be cured by the curing section.

10. A control device that is used in a printing device including a discharge head configured to discharge fluid, a connection section to which an accommodation member that accommodates the fluid is connectable, a fluid flow path that connects the discharge head and the connection section, a liquid feeding section configured to cause the fluid to flow through the fluid flow path, and a detection section provided in the fluid flow path, the detection section being configured to detect whether the fluid is present in the fluid flow path and/or measure an amount of the fluid accommodated in the accommodation member, the control device comprising:
a control section configured to perform connection state determination as to whether a connection state of the connection section is normal based on a detection value of the detection section when the liquid feeding section causes the fluid to flow through the fluid flow path.

11. A method for controlling a printing device including a discharge head configured to discharge fluid, a connection section to which an accommodation member that accommodates the fluid is connectable, a fluid flow path that connects the discharge head and the connection section, a liquid feeding section configured to cause the fluid to flow through the fluid flow path, and a detection section provided in the fluid flow path, the detection section being configured to detect whether the fluid is present in the fluid flow path and/or measure an amount of the fluid accommodated in the accommodation member, the method comprising:
a step of performing connection state determination as to whether a connection state of the connection section is normal based on a detection value of the detection section when the liquid feeding section causes the fluid to flow through the fluid flow path.
